(19) United States
(12) Patent Application Publication
(10) Pub. No.: US 2014/0125702 A1
(43) Pub. Date: May 8, 2014

(54) SYSTEM AND METHOD FOR GENERATING AN IMMERSIVE VIRTUAL ENVIRONMENT USING REAL-TIME AUGMENTATION OF GEO-LOCATION INFORMATION

(71) Applicant: Fairways 360, Inc., Plano, TX (US)

(72) Inventors: Juan Santillan, Plano, TX (US); Ben Humphrey, Farmington, UT (US); Marc Schaerer, Rueti (CH)

(73) Assignee: Fairways 360, Inc., Plano, TX (US)

(21) Appl. No.: 14/053,624

(22) Filed: Dec. 17, 2013

Related U.S. Application Data
(60) Provisional application No. 61/713,947, filed on Oct. 15, 2012.

(51) Int. Cl. G06T 19/00

(52) U.S. Cl. CPC G06T 19/006
USPC 345/633

(57) ABSTRACT

A system and method for generating an immersive virtual environment using real-time augmentation of geo-location information.

### FIELD OF THE INVENTION

The present disclosure relates generally to the field of data processing, and in particular but not exclusively, relates to a system and method for generating an immersive virtual environment using real-time augmentation of geo-location information.

### BACKGROUND OF THE INVENTION

Modern computer games demands increasing amounts of complex content in the form of virtual environments, ecologies, and interconnected systems. As a result, professional game designers and artists are required to spend significant time and expense hand-creating such content, e.g., the artwork, textures, layouts, and procedures that form virtual environments.

After such efforts are expended, the resulting virtual environment, because it has been “hard-coded” into the system, is often static, unchanging, and does not respond greatly to player interaction. To address these issues, an external geo-locator or geo-marker, such as GPS, may be used to orient a virtual user within the environment. However, such geo-location requires extensive interaction between the external geo-locator and the virtual environment.

### SUMMARY OF THE INVENTION

The current disclosure describes a system and method to for generating an immersive virtual environment using real-time augmentation of geo-location information.

The virtual environment is an operating environment stored or located on a server. The server may be a physical server, a cloud-based service, or another type of distributed network.

A user may connect to, download or access the user interface on their user device. The user interface may be used to allow interaction between the user and the virtual environment. The user interface may require a secure login or verification process.

The user interface may present content indicating the location information. The user interface may include presentation of a first person perspective based on determined location, directional heading, and angle of elevation of a user device. The user interface may include the presentation of a 360° panoramic view based on determined location of a user device.

The virtual environment may present the user requested content through computer generated images and actual filmed and stored geophysical locations or a combination of both. The filmed content may be previously filmed or concurrently streamed from the user's device. If the content is concurrently streamed from the user's device, the virtual environment is overlaid on the user generated content.

According to another embodiment, a system including, without limitation, a computer-readable storage medium carrying one or more sequences of one or more instructions which, when executed by one or more processors, cause, at least in part, a user device to receive an access address of content, the content including the virtual environment and associated location information. The system user interface may include presentation of a first person perspective based on determined location, directional heading, and angle of elevation of a user device. The user interface may include the presentation of a 360° panoramic view based on determined location of a user device.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other objectives, features and advantages of the invention will become apparent from the following description and drawings wherein.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a block diagram illustrating an operating environment for generating an immersive virtual environment using real-time augmentation of geo-location information in an embodiment.

FIG. 2 is a block diagram illustrating the operative components of a system for generating an immersive virtual environment using real-time augmentation of geo-location information in an embodiment.

FIG. 3 is a block diagram illustrating the operative components of a client device used in a system for generating an immersive virtual environment using real-time augmentation of geo-location information in an embodiment.

FIG. 4 is a block diagram illustrating the operative components of a web server used in a system for generating an immersive virtual environment using real-time augmentation of geo-location information in an embodiment.

FIG. 5 is a block diagram illustrating the operative components of a media server in a system for generating an immersive virtual environment using real-time augmentation of geo-location information in an embodiment.

FIG. 6 is a flowchart illustrating a process for transmitting data used in a system for generating an immersive virtual environment using real-time augmentation of geo-location information in an embodiment.

FIG. 7 is a block diagram illustrating the operative components of an image engine used in a system for generating an immersive virtual environment using real-time augmentation of geo-location information in an embodiment.

FIG. 8 is a flow chart illustrating a process for transmitting image data used in a system for generating an immersive virtual environment using real-time augmentation of geo-location information in an embodiment.

FIG. 9 is an illustration of an immersive virtual environment using real-time augmentation of geo-location information in a live operational mode in an embodiment.

FIG. 10 is an illustration of an immersive virtual environment using real-time augmentation of geo-location information in a live operational mode in an embodiment.

FIG. 11 is an illustration of an immersive virtual environment using real-time augmentation of geo-location information in a live operational mode in an embodiment.

### DETAILED DESCRIPTION

In the description to follow, various aspects of embodiments will be described, and specific configurations will be set forth. These embodiments, however, may be practiced with only some or all aspects, and/or without some of these specific details. In other instances, well-known features are omitted or simplified in order not to obscure important aspects of the embodiments.

Various operations will be described as multiple discrete steps in a manner that is most helpful for understanding each disclosed embodiment; however, the order of description should not be construed to imply that these operations are necessarily order dependent. In particular, these operations need not be performed in the order of presentation.

The description repeatedly uses the phrases “in one embodiment”, which ordinarily does not refer to the same embodiment, although it may. The terms “comprising”, “including”, “having”, and the like, as used in the present disclosure are synonymous.

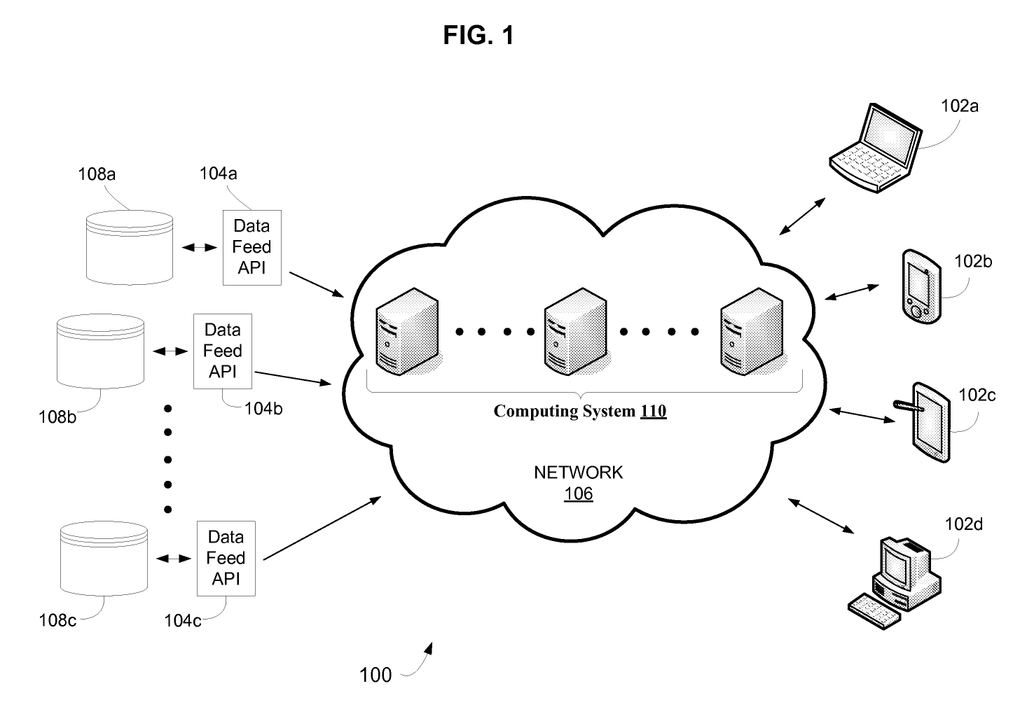

Referring now to FIG. 1, in one embodiment, operating environment 100 is for used for the generation of an immersive virtual environment using real-time augmentation of geo-location information. In this embodiment, client devices 102a, 102b, 102c, 102d are communicatively coupled to a network 106 that enables communication with one or more servers of a computing system 110 for generating an immersive virtual environment that is shown on the user interfaces used on the client devices 102a, 102b, 102c, 102d. Users of the client devices 102a, 102b, 102c, and 102d that are communicatively coupled to the computing system 110 view and engage in simulated and virtual experiences in the immersive environment.

The immersive environment shown on the client devices 102a, 102b, 102c, 102d is generated from raw data that is streamed from one or more data feed application programming interfaces 104a, 104b, 104c each of which are connected or coupled to stored location data or a video or image capture device located at a physical location, such as a sports arena, an athletic field (e.g., golf courses, baseball course, football stadiums, basketball stadiums, etc.), or other specific geographic locations where events with live or simultaneous actions occur (e.g., industrial manufacturing environments, product assembly environments, etc.).

In an embodiment, each image capture device will have a local storage resource 108a, 108b, 108c (e.g., program memory, secondary storage, etc.) for storing images, videos, and pertinent metadata including real-time geographic-specific location data (e.g., GPS coordinates, time of day, etc.).

In an embodiment, the immersive virtual environment executed on the client devices 102a, 102b, 102c, 102d has two operational modes, a “Live Play Mode” and a “Game Play Mode.”

In the Live Play Mode, a viewer is able to observe in real-time the actions of players and the objects they act upon (e.g., golf balls, baseballs, basketballs, etc.) in a computer-generated virtual environment that is identical to the actual playing field or location where an event such as a sports competition is taking place. In an embodiment, an individual player may be “followed” throughout the event by a user. Furthermore, in this operational mode, viewers are able to maneuver throughout the immersive environment from using a camera view providing either a full 360 degree or 180 degree viewing perspective from any points in the location rendered in the immersive environment. Additionally, the immersive environment and objects or players within, may overlaid with pertinent facts and statistics relating to the event and/or participants that are being observed.

In Game Play Mode, a viewer observing a simulated location in an immersive virtual environment can take control of objects rendered in the environment and engage in competitive play or other actions with those objects. Among the range of objects that can be simulated and used in the immersive environment are sporting goods (e.g., golf balls, baseball bats, footballs, etc.) and simulated representations of players in games or other simulated events. In this mode, the simulated representations of players can be controlled and used by viewers from their client devices 102a, 102b, 102c, 102d in addition to affecting or controlling the placement and locations of the objects acted upon by the simulated players.

In both the Live Play Mode and the Game Play Mode, the computing system 110 can generate an immersive virtual environment that enables interaction with full three-dimensional representations of objects and players in the simulated environment.

The client devices 102a, 102b, 102c, 102d may have device-specific browsers, applications, software programs or other graphical user interfaces that can render the immersive virtual environments for full user interactivity. Among the range of client devices used with the computing system 110 are personal digital assistants (PDAs), cell phones, smart phones, tablet computers, desktop computer, laptop computers, portable media players, handheld game consoles, digital cameras, e-book readers and other smart mobile technologies enabling end-users to gain access to computer communications networks such as the Internet. In the illustrated embodiment, the network 106 may be the Internet. In other embodiments, the network 106 can be a private computer communications network, a wireless communications network, a peer-to-peer network or other computer data communications network that can enable communications between computing or data processing devices and a myriad of end-user client devices 102a, 102b, 102c, 102d.

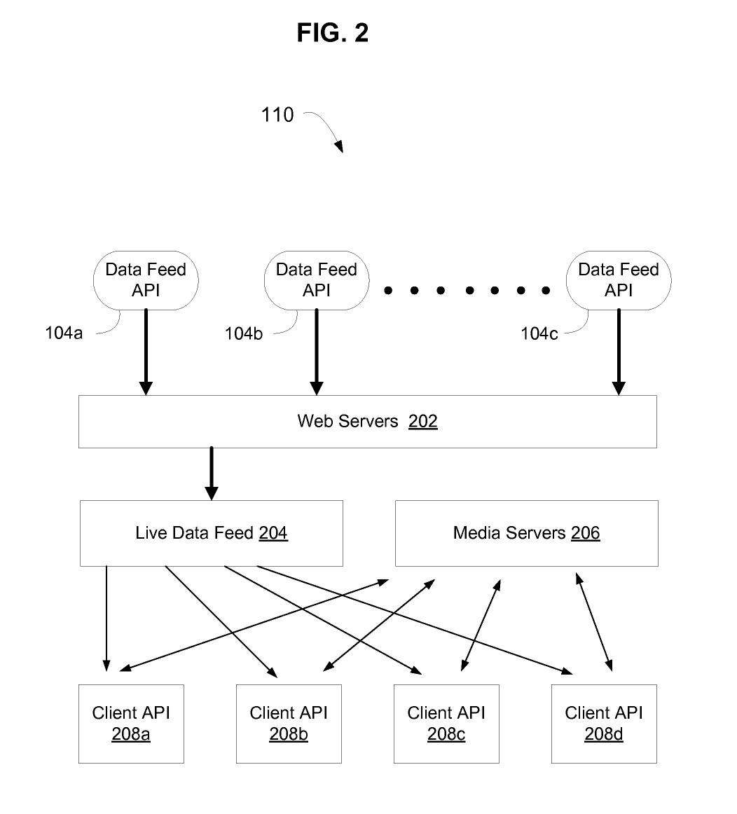

Referring now to FIG. 2, the computing system 110 used for generating an immersive virtual environment using real-time augmentation of geo-location information. As shown, data feed application programming interfaces (each referred to as a “data feed API”) 104a, 104b, 104c are communicatively coupled to a network of web servers 202 that receive and process the data provided from the data feed APIs 104 to generate live data feeds 204 which are transmitted to client application programming interfaces 208a, 208b, 208c, and 208d (each referred to as a “client API”). Each client API is connected or coupled to a client device 102a, 102b, 102c, 102d used by an end-user who can view or engage in activities in the immersive virtual environment executed on each client device 102a, 102b, 102c, 102d. Each data feed API 104a, 104b, 104c generates and transmits raw data to the web servers 202 and the web servers use this raw data to generate live data feeds 204 that are transmitted to one or more client APIs 208a, 208b, 208c. After receipt of data in a live data feed 204 by a client API 208a, 208b, 208c, a client application on each client device 102a, 102b, 102c, 102d will parse and process the received data and transmit queries to a network of media servers 206 to retrieve image files for rendering in the immersive virtual environment, or video files for execution and display in the immersive virtual environment.

The computing system 110 illustrated in this embodiment may include two or more distinct layers of servers, a network of web servers 202 and a network of media servers 206. The live data feed 204 includes the contents of the raw data sourced from each of the data feed APIs 104a, 104b, 104c from each monitored environment, playing field or athletic location as well as references to related image files and video files stored on the media servers 206. The raw data may also include relevant metadata such as GPS location, time, date, image resolution, and a unique location identifier (e.g., unique identifier for Augusta National Golf Club, Yankee Stadium, Mile High Stadium, etc.). In this manner, the live data feed 204 provides each client device 102a, 102b, 102c, 102d with access to the appropriate raw data to accurately render simulations of actual locations where events are occurring that can be viewed and experienced by participants in the immersive virtual environments who use the client devices 102a, 102b, 102c, 102d. The live data feed 204 also includes the references to storage locations in the memory maintained on the network of media servers 206 to image files and video files required for representation of the simulated locations in the browsers or other viewing resources used on the client devices 102a, 102b, 102c, 102d.

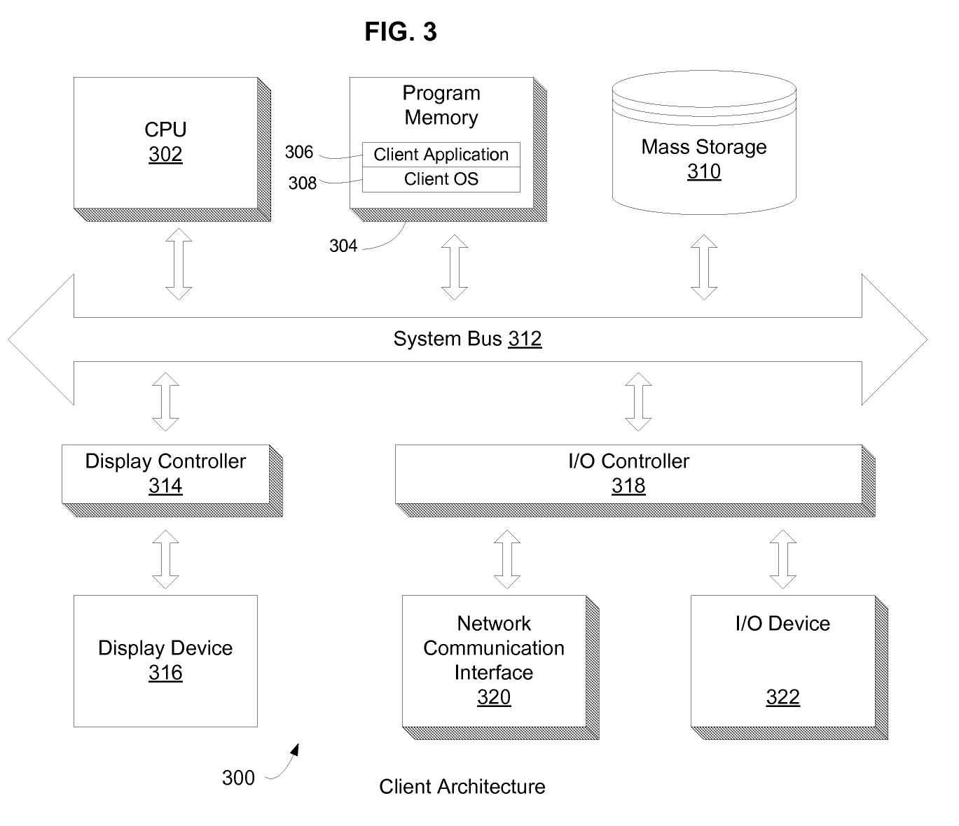

Referring now to FIG. 3, the operative components in each client device 102a, 102b, 102c, 102d may include a central processing unit (CPU) 302, a program memory 304, a mass storage resource 310 (e.g., external hard disks, etc.), a display controller 314 and an input/output controller 318. Each of these devices is communicatively coupled to a system bus 312 to ensure prompt, efficient and effective inter-component communications and the passing of relevant instructions and/or data for the processing of data received for the rendering of an immersive virtual environment in a user interface on the client device 102a, 102b, 102c, 102d. The program memory 304 includes a local client operating system (“Client OS”) 308 and a client application 306.

The client application 306, in an embodiment, can generate client queries to the network of media servers 206, which queries can include requests for image files or video files of specific simulated environments shown in an immersive virtual environment. The display controller 314 is communicatively coupled to a display device 316 such as a monitor or display on which a graphical user interface (e.g., a browser, application, software program etc.) is provided for use by end-users. The input/output controller 318 is communicatively coupled to one or more input/output devices. In the illustrated embodiment, the input/output controller 318 is communicatively coupled to a network communication interface 320 and an input/output device 322 such as, without limitation, a voice recognition system, mouse, touchscreen, stylus or keyboard.

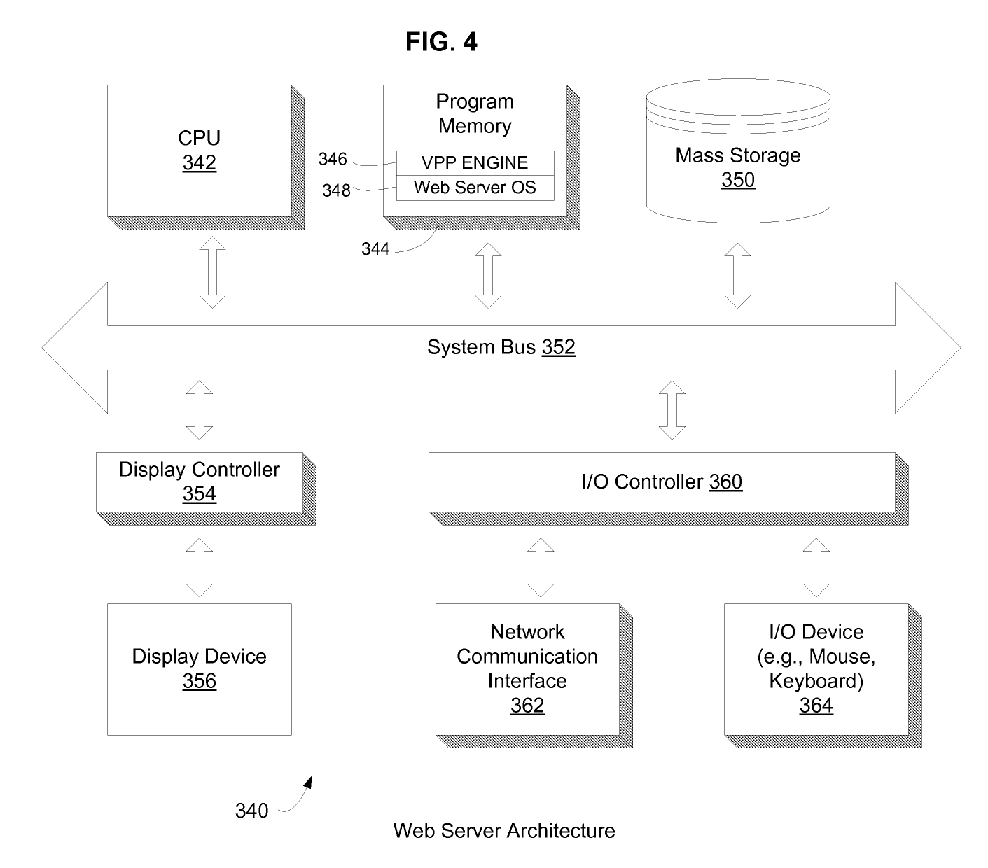

Referring now to FIG. 4 the operative components of each web server used in the network of web servers 202, in an embodiment, includes a central processing unit (CPU) 342, a program memory 344, a mass storage resource 350 (e.g., external hard disks, etc.), a system bus 352, a display controller 354 and an input/output controller 360. The display controller 354 and the input/output controller are communicatively coupled to the system bus 352. The CPU 342, the program memory 344 and the mass storage device 350 are also communicatively coupled to the system bus 352 to ensure that messages and other information can be transferred between these operative components. The program memory 344 includes a web server operating system 348 (i.e., a “Web Server OS”) and a VPP engine 346 that (i) continuously monitors and requests data from the data feed APIs 104a, 104b, 104c, (ii) manages a data input queue, retrieves locally stored image files and video files from the mass storage resource 350, and (iii) generates and transmits live data feeds 204 to the client APIs 208a, 208b, 208c. The abbreviation “VPP” represents the term Virtual-Play-By-Play™ which is intended to be used as a source indicator for products incorporating the VPP engine 346 for the generation of immersive virtual environments for execution on the client devices 102a, 102b, 102c, 102d. An additional component is the display controller 354 and it is communicatively coupled to one or more display devices 356. The input/output controller 360 is communicatively coupled to one or more input/output devices. In this embodiment, a network communication interface 362 is provided and an input/output device 364 such as a mouse or keyboard is also provided. In one embodiment, the network communication interface 362 is used for the transmission of queries and data requests from the data feed APIs 104a, 104b, 104c for the receipt of raw data from various sensing devices. The network communication interface 362 is also used for the transmission of live data feeds 204 to the client APIs 208a, 208b, 208c.

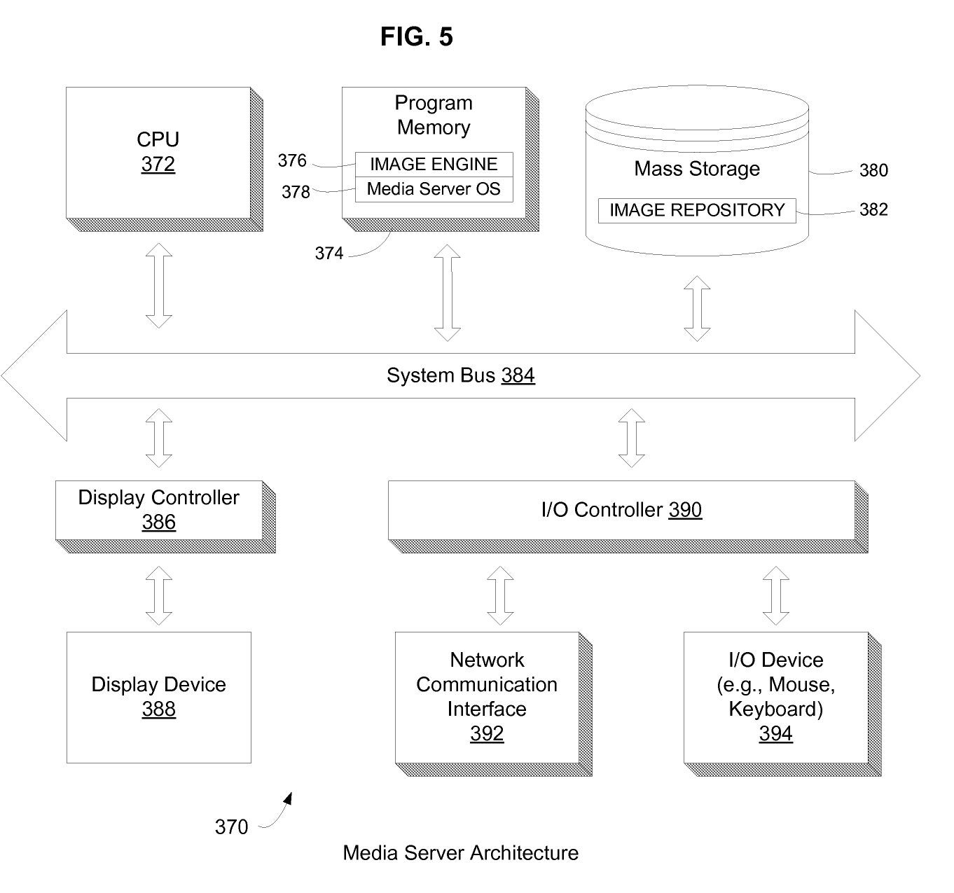

Referring now to FIG. 5, the operative components in a media server in the media server network 206 are depicted. This embodiment includes a central processing unit (CPU) 372, a program memory 374 and a mass storage resource 380, each of which are communicatively coupled to a system bus 384. The program memory 374 includes a media server operating system 378 (a “Media Server OS”) and an image engine 376. The mass storage resource includes an image repository 382 and it is a stored repository of image files and video files that are used to render the immersive virtual environments which are executed and viewed on the client devices 102a, 102b, 102c, 102d. Access to the image repository 382 is controlled by the image engine 376 and access is provided if the image engine 376 receives queries from client devices which include requests for specific image files and video files for the rendering of immersive virtual environments to be viewed on each of the client devices 102a, 102b, 102c, 102d.

In addition to the above-listed components, each media server also includes a display controller 386 which is communicatively coupled to the system 384 and a display device 388 (e.g., a monitor or other viewing device on which a graphical user interface may be executed, etc.). Each media server also includes an input/output controller 390 which is communicatively coupled to the system bus 384 and to a network communication interface 392 and an input/output device 394 (e.g., a mouse, touch screen, keyboard, stylus, voice recognition system). The system bus 384 is used for the transfer of messages between the operative components of the media server such as client queries received on the network communication interface 392 for transmission to the image engine 396 through the input/output controller 390 and over the system bus 384. The image engine 376 places each client query in a queue and dynamically adjusts the size of the queue to maintain a desired response times for each query seeking access to and retrieval of image files and video files stored in the image repository 382. Once identified in the client query, the requested images and/or video files in the image repository 382 are retrieved and transferred over the system bus 384, through the input/output controller 390 to the network communication interface 392 for prompt transmission to the requesting client devices 102a, 102b, 102c, 102d.

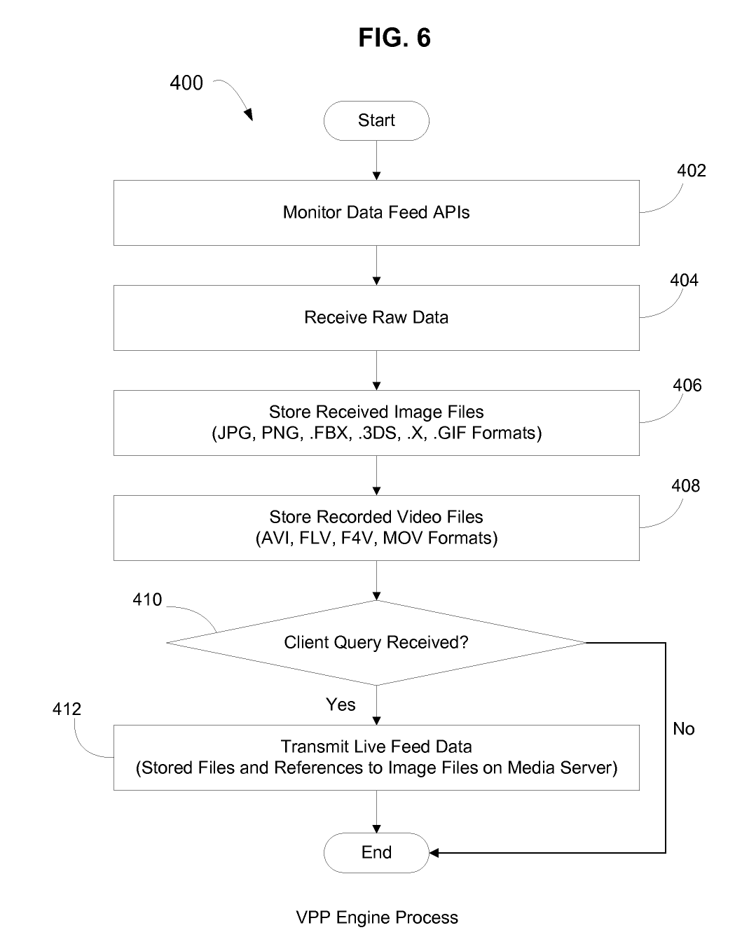

Referring now to FIG. 6, the process 400 is performed by the VPP engine 346 on each of the web servers in the network of web servers 202. The process 400 commences with continuous monitoring of data feed APIs, as shown at step 402, and the receiving of raw data 404 on an ongoing basis from the data feed APIs 104a, 104b, 104c in response to the continuous monitoring, as shown at step 404. After raw data is received, image files received in the raw data are stored in a local memory or storage of the web servers. The image files received can be in any of a number of file formats, including files in the JPG, PNG, .FBX, .3DS, .X, and .GIF file formats, as shown at step 406. This process also includes the storing and recording of video files received in the raw data, as shown at step 408. Among the formats that can be received in the raw data and stored for use in the computing system 110 are files in the following formats: AVI, FLV, F4V, and MOV. As discussed previously, the data feed APIs are continuously monitored and data is received and stored from various locations on an ongoing basis.

If a client query is received, as shown at step 410, for data needed for the rendering of an immersive virtual environment on a from a client device 102a, 102b, 102c, 102d, particularly for the specific view of a user within an immersive virtual environment, then the VPP engine 346 will compile raw data, references to stored image files on the media server, and applicable stored files in the local memory of a web server and generate a new live data feed for transmission to a requesting client API, as shown at step 412. However, if a web server does not receive a client query, it will continuously monitor the data feed APIs, as shown at step 402, and continue to receive raw data and store image files and video files relevant to a rendered immersive virtual environment to ensure that maximum data is available for full rendering of all user views within a virtual environment as needed.

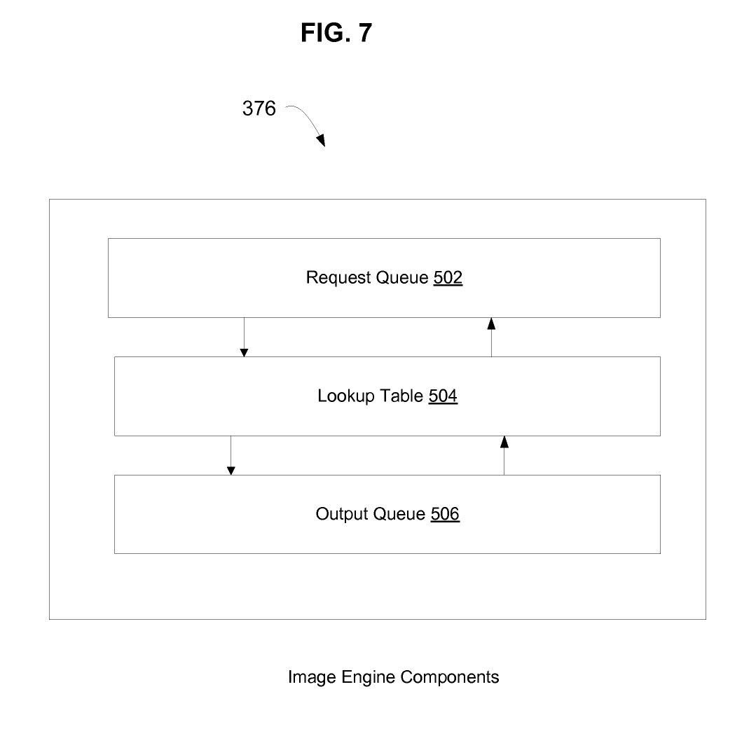

Referring now to FIG. 7, the operative components of the image engine 376 includes a request queue 502 which is used to receive pending client queries and requests for new image and/or video files. This request queue 502 periodically sends a message to the CPU to execute a new data retrieval request using a lookup table 504 for access to the applicable stored image or video file. In response to a received message from the request queue 502, the CPU will send a new file request message to the lookup table 504 requesting the identification of the location of the requested image or video file in the mass storage resource on a media server. In reply to these requests, the lookup table 504 sends confirmation of its receipt of the new file request message to the request queue 502. In addition to sending confirmation, image engine 376 also sends the address or other location information of the requested image files and/or video files to the CPU of the media server. The lookup table 504 also sends messages to an output queue 506 and the CPU to enable the CPU to retrieve the requested image files and/or video files and to transmit newly compiled data and files in the output queue 506 to the requesting client APIs 208. As data feeds are transmitted to client APIs 208a, 208b, 208c, the output queue 506 sends notification to the lookup table 504 and the CPU of the availability of free space in the output queue 506 that can be used to reply to new requests from client APIs 208a, 208b, 208c.

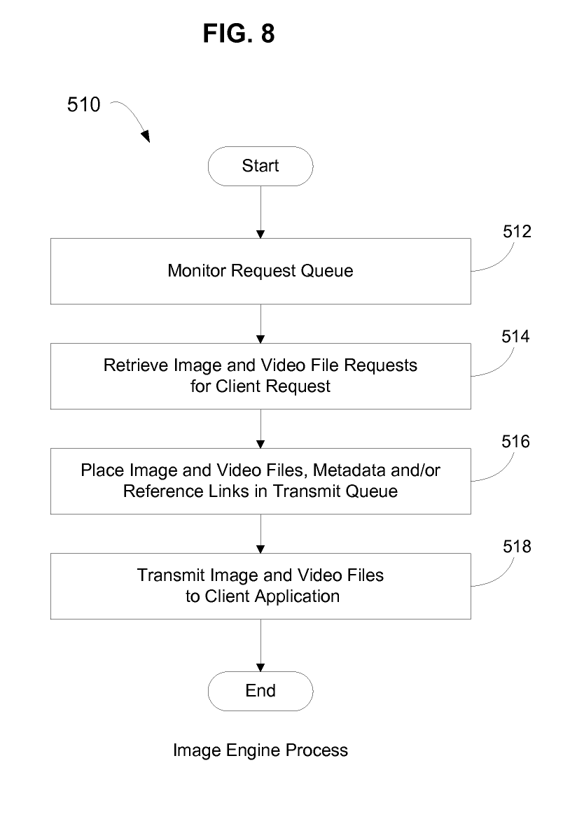

Referring now to FIG. 8 the process 510 performed on the image engine 376 on each media server begins with the active monitoring of a request queue, as shown at step 512, and, upon receipt of a message request in the request queue, the retrieval of image and video files for each client request received in the request queue, as shown at step 514. After receipt of each request, the image engine can transmit one or more messages to the image repository 382 requesting that the required image and video files, related metadata (e.g., GPS coordinates, etc.) and/or reference links be placed in a transmit queue, as shown at step 516. After the required files and data are placed in the transmit queue, the image engine 376 can transmit the image files and video files to a client application executing on the client device 102 which initially transmitted the request received in the request query, as shown at step 518.

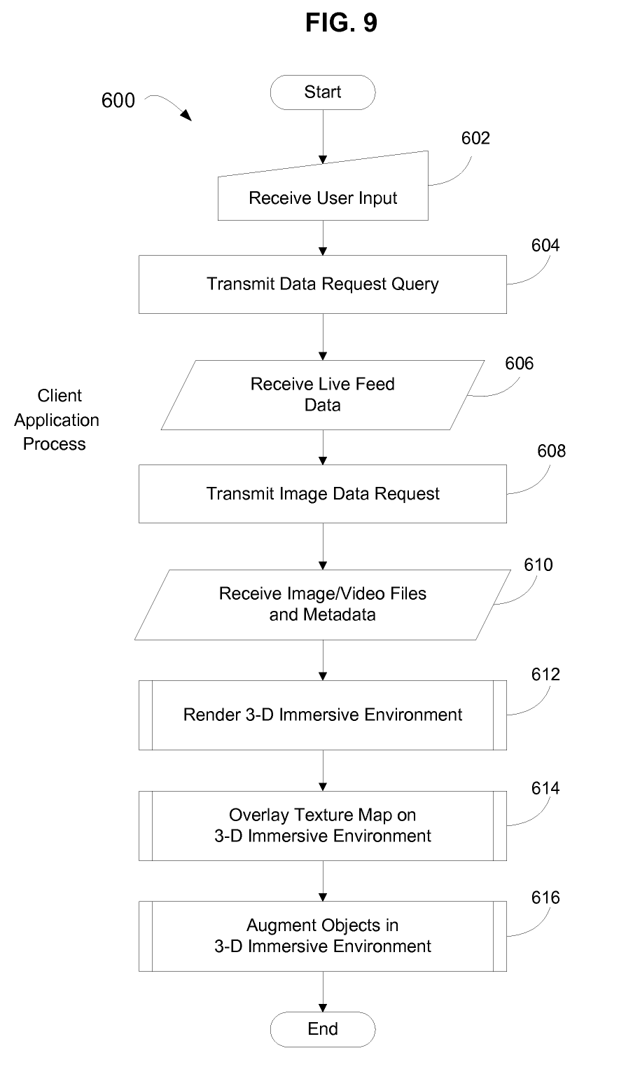

Referring now to FIG. 9, the process 600 performed in a client application 306 commences with the receiving of user input, as shown at step 602, which can include a selection of objects rendered in an immersive virtual environment used by an end-user who is an active viewer or participant in the virtual environment. After receiving user input, a client device 102a, 102b, 102c, 102d will transmit a data request query, as shown at step 604. In response to the transmission of the data request query, the client device will begin receiving a live data feed, as shown at step 606, which includes raw data received from one or more data feed APIs. The received live data feed also includes references to stored image files or video files required for the full and complete rendering of objects, scenes and other required information for display in the immersive virtual environment. In this case, the client device transmits an image data request, as shown at step 608, and in response will receive image and video files and related metadata, as shown at step 602, and then execute a process for rendering a three-dimensional immersive environment reflecting the data and information in the image files, video files and metadata received from the media servers and the web servers, as shown at step 612. An additional process is also performed to overlay a texture map on a three-dimensional geometric spatial structure in which the immersive virtual environment will be represented that will be specific to the view of the user engaged in the viewing of actions in the environment while in Live Play Mode or while engaged in controlling simulated objects and actors in Game Play Mode in the immersive virtual environment. Once a texture map is overlaid on the immersive virtual environment, objects or players will be augmented in real-time and displayed in the immersive virtual environment to provide an accurate and realistic viewing perspective for all actions occurring in the immersive virtual environment, as shown at step 616. Real-time augmentation of data, statistics and other information presented in an immersive virtual environment is accomplished with the continuous receipt and processing of data from a live data feed 204 transmitted from a network of web servers 202 and the continuous updating and receipt of image files and video files transmitted from a network of media servers 206.

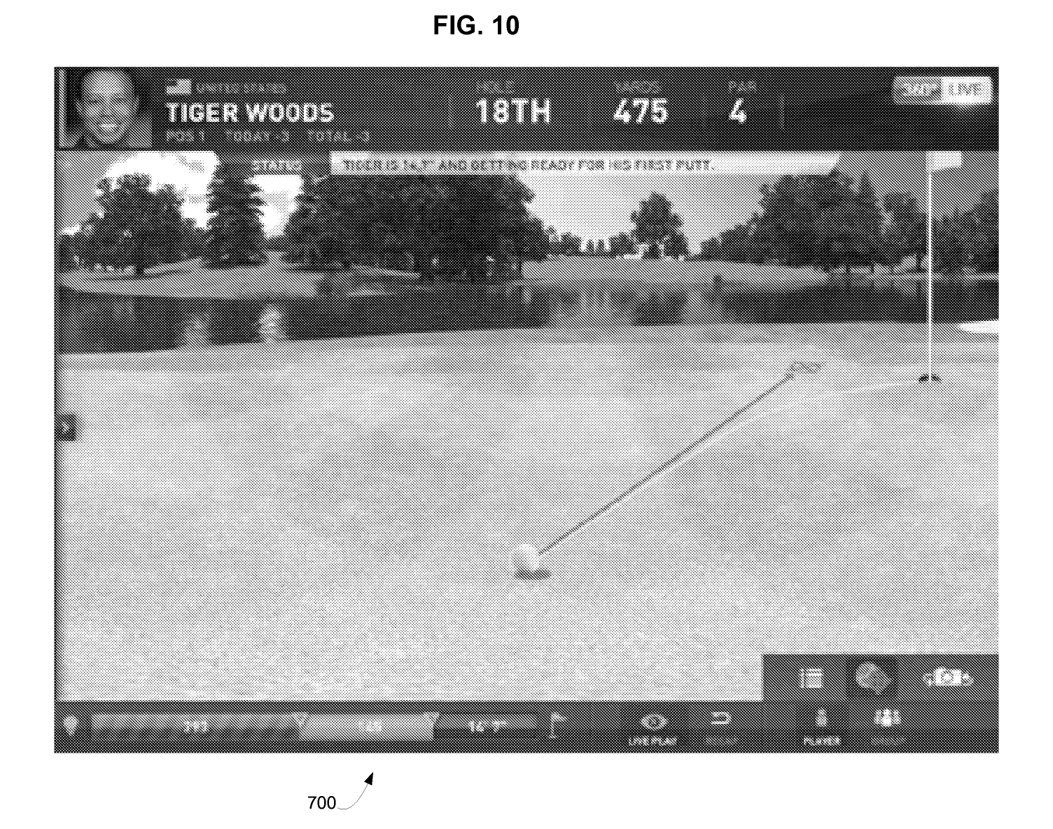

Referring now to FIG. 10, an embodiment 700 of an immersive virtual environment in “Live Play Mode” showing a viewer observing Tiger Woods, the famous golfer, playing at the 18th hole, par 4 on an actual golf course. The viewer views a simulated immersive environment that accurately represents the golf course where Tiger Woods is actually playing at the time of viewing the actions reflected in this environment. Relevant geo-location data and statistics about the game are overlaid and continuously augmented in real-time in the viewing environment as the action unfolds.

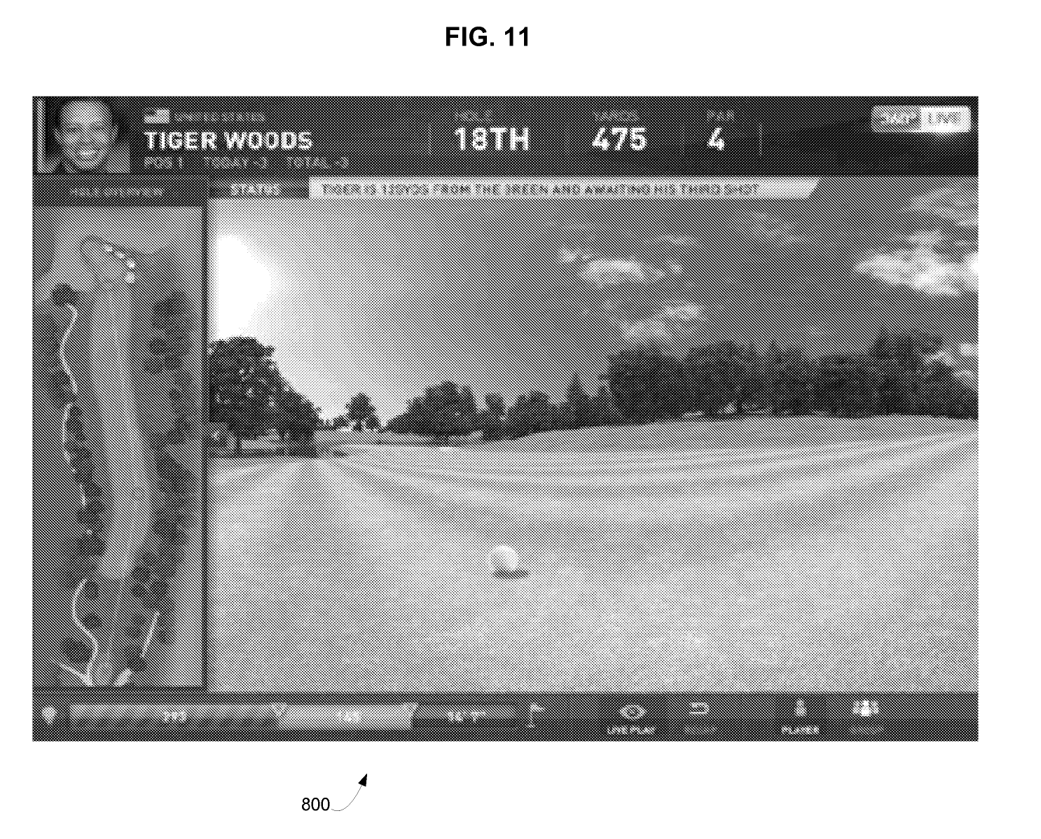

Referring now to FIG. 11 an additional view of an embodiment 800 of the immersive virtual environment in “Live Play Mode” in which a user views a golf ball lying on a golf course where Tiger Woods is playing and receives pertinent statistics about the current play action. In the present case, the viewer is viewing a golf ball on or near the 18th hole, par 4 and receives data indicating that the ball is 475 yards away from the 18th hole. The view also provides the user with additional features to enhance the viewing experience so as to enhance the experience of the user while the actual player is participating in the viewed sporting event.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

We claim:

1. A system for generating an immersive virtual environment using real-time augmentation of geo-location information comprising:
at least a first computational device including at least a first graphics processing unit,
at least a first set of instructions,
at least a first local storage resource containing one or more of the following group: geo-locative data, temporal data, individual performance data, and team performance data.
a user device containing a user interface, and
a network communicatively coupled to the at least a first computational device, the local storage resource, and the user device,
wherein the first computational device processes input from the user interface on the user device according to the at least a first set of instructions and references and retrieves data from the at least a first local storage resource in response to the input from the user interface.

2. The system of claim 1, wherein the first set of instructions further comprises one of the following group: a system program, an application, a cloud-based program.

3. The system of claim 1, wherein the at least a first local storage resource is one or more storage resources.

4. The system of claim 1, wherein the at least a first local storage resource is a media server.

5. The system of claim 1, wherein the user device is further comprised of one of the following group: a personal digital assistant (PDA), a cell phone, a smart phone, a tablet computer, a desktop computer, a laptop computer, a portable media player, a handheld game console, a digital camera, or an e-book reader.

6. The system of claim 1, wherein the network is further comprised of one of the following group: a private computer communications network, a wireless communications network, a peer-to-peer network.

7. The system of claim 1, wherein the data retrieved from the at least a first local storage resource in response to the input from the user interface further comprises a display in a first person perspective based on the determined location of the user device.

8. The system of claim 1, wherein the data retrieved from the at least a first local storage resource in response to the input from the user interface further comprises a display in a first person perspective based on the directional heading of the user device.

9. The system of claim 1, wherein the data retrieved from the at least a first local storage resource in response to the input from the user interface further comprises a display in a first person perspective based on the angle of elevation of the user device.

10. The system of claim 1, wherein the data retrieved from the at least a first local storage resource in response to the input from the user interface further comprises historical data from one or more of the following group: location data, event data, player data or team data.

11. The method of generating an immersive virtual environment using real-time augmentation of geo-location information comprising:
providing at least a first computational device including at least a first graphics processing unit,
providing at least a first set of instructions,
providing at least a first local storage resource containing one or more of the following group: geo-locative data, temporal data, individual performance data, and team performance data.
providing a user device containing a user interface, and
providing a network communicatively coupled to the at least a first computational device, the local storage resource, and the user device,
wherein the first computational device processes input from the user interface on the user device according to the at least a first set of instructions and references and retrieves data from the at least a first local storage resource in response to the input from the user interface.

12. The method of claim 11 wherein the step of providing the at least a first set of instructions further comprises providing one of the following group: a system program, an application, a cloud-based program.

13. The method of claim 11, wherein the step of providing the at least a first local storage resource further comprises providing one or more storage resources.

14. The method of claim 11, wherein the step of providing the at least a first local storage resource further comprises providing a media server.

15. The method of claim 11, wherein the step of providing the user device further comprises providing of one of the following group: a personal digital assistant (PDA), a cell phone, a smart phone, a tablet computer, a desktop computer, a laptop computer, a portable media player, a handheld game console, a digital camera, or an e-book reader.

16. The method of claim 11, wherein the step of providing the network further comprises providing of one of the following group: a private computer communications network, a wireless communications network, a peer-to-peer network.

17. The method of claim 11, wherein the step of providing the data retrieved from the at least a first local storage resource in response to the input from the user interface further comprises providing a display in a first person perspective based on the determined location of the user device.

18. The method of claim 11, wherein the step of providing the data retrieved from the at least a first local storage resource in response to the input from the user interface further comprises providing a display in a first person perspective based on the directional heading of the user device.

19. The method of claim 11, wherein the step of providing the data retrieved from the at least a first local storage resource in response to the input from the user interface further comprises providing a display in a first person perspective based on the angle of elevation of the user device.

20. The method of claim 11, wherein the step of providing the data retrieved from the at least a first local storage resource in response to the input from the user interface further comprises providing historical data from one or more of the following group: location data, event data, player data or team data.
